(19) United States
(12) Patent Application Publication
(10) Pub. No.: US 2023/0347568 A1
(43) Pub. Date: Nov. 2, 2023

(54) SUBSTRATE SHEET FOR DECORATIVE FLOOR OR WALL COVERING

(71) Applicant: TARKETT GDL, LENTZWEILER (LU)

(72) Inventors: Igor BRANKOV, Wiltz (LU); Diego OURDIN, Wiltz (LU)

(21) Appl. No.: 17/778,971

(22) PCT Filed: Dec. 7, 2020
(86) PCT No.: PCT/EP2020/084900

§ 371 Date: May 23, 2022

(30) Foreign Application Priority Data
Dec. 12, 2019 (LU) LU101525

(51) Int. Cl. B29C 48/17; B29C 48/07; B29C 48/21

(52) U.S. Cl. CPC B29C 48/17; B29C 48/07; B29C 48/21; B29K 2027/06

(57) ABSTRACT

Aspects of the present invention relates to a method for producing a substrate sheet for a decorative floor or wall covering (10), a method for producing a decorative floor or wall covering and a decorative floor or wall covering (10). The method for producing a substrate sheet comprises providing a first thermoplastic composition comprising recycled PVC granules (S2), the first thermoplastic composition (S2) having a shade. In addition the method comprises admixing a darkener to the first thermoplastic composition so as to obtain a first thermoplastic composition having a specific shade (S6). A second thermoplastic composition (S4) is also provided. The method further comprises coextruding (S8) the first thermoplastic composition (S2) having a specific shade with the second composition (S4) so as to form a first and a second adjacent coextruded layers. The first coextruded layer is a support layer having the specific shade, the first coextruded layer comprising the first thermoplastic composition (S2). The second coextruded layer is a digitally printable layer, the second coextruded layer comprising the second thermoplastic composition (S4).

### FIELD OF THE INVENTION

The invention relates to a method for producing a substrate sheet for a decorative floor or wall covering, a decorative floor or wall covering comprising the substrate sheet and a method for producing the decorative floor or wall covering.

### BACKGROUND OF THE INVENTION

Document EP 3 326 815 A1 teaches a method of forming layering structure of plastic flooring comprising steps of:
A. forming the substrate by using an extruder so as to one-piece extrusion form the substrate including at least two sheets, wherein the at least two sheets are a first sheet and a second sheet which stack together;
B. delivering a printing layer, wherein the printing layer has patterns printed thereon and is delivered to the roller unit by using a second rolling mechanism and a second pressing mechanism;
C. conveying the abrasion resistant layer, wherein the abrasion resistant layer conveyed to the roller unit byway of a second rolling mechanism and a second pressing mechanism of the rolling conveyor; and
D. roll pressing the substrate, the printing layer, and the abrasion resistant layer together by way of the roller unit so as to form the plastic flooring, and the plastic flooring is removed and cut based on required sizes.

### GENERAL DESCRIPTION

A first aspect of the present invention relates to a method for producing a substrate sheet for a decorative floor or wall covering. The method comprises providing a first thermoplastic composition comprising recycled polyvinyl chloride (PVC) granules, the first thermoplastic composition having a shade, and providing a second thermoplastic composition. The method further comprises admixing a darkener to the first thermoplastic composition so as to obtain a first thermoplastic composition having a specific shade. The first thermoplastic composition having a specific shade is coextruded with the second composition so as to form a first and a second adjacent coextruded layers. The first coextruded layer is a support layer having the specific shade. The support layer comprises the first thermoplastic composition. The second coextruded layer is a digitally printable layer. The digitally printable layer comprises the second thermoplastic composition. The admixing of the darkener to the first thermoplastic composition is carried out purposefully to achieve the specific shade, which is known (predetermined), i.e. desired shade. In other words, the specific shade is the target parameter (specific target shade) of the admixing of darkener.

As used herein, a thermoplastic composition is a plastic polymer composition that becomes pliable or mouldable above a certain temperature and solidifies upon cooling.

The recycled PVC may originate from a plurality of sources (e.g. PVC products, or PVC semi-finished products). As such, the composition, colour, shade, geometry, size, physical and/or chemical properties of recycled PVC granules may greatly vary. Typically, the size of the PVC granules is less than 1000 μm, preferably less than 800 μm and even more preferably less than 300 μm. The size of the PVC granules may be measured by a sieve.

As used herein, a colour of an object is a property of the object to produce different sensations on the eye as a result of the way it reflects or emits light (e.g. blue). The shade is the relative darkness of a colour (e.g. light blue, dark blue).

As used herein, a support layer is a layer that provides structural support (e.g. rigidity) to substrate sheet and also to the finished decorative floor or wall covering.

As used herein, a digitally printable layer is a layer that is preferably substantially white, i.e. having a lightness L* defined in the CIELAB colour space greater than 80, preferably greater than 85 and even more preferably greater than 90. The digitally printable layer preferably has a predetermined shade, which is brighter than the specific shade of the first thermoplastic composition. According to an embodiment, the digitally printable layer has a surface energy comprised in the interval between 15 mN/m and 60 mN/m, preferably in the interval from 20 mN/m to 50 mN/m and even more preferably in the interval from 25 mN/m to 40 mN/m. The digitally printable layer may have a surface roughness Ra of less than 0.5 μm, preferably of less than 0.3 μm and even more preferably of less than 0.2 μm. The digitally printable layer may have a surface roughness P % of less than 5 μm, preferably of less than 3 μm and even more preferably of less than 2 μm. The surface roughness is measured according to ISO 4288:1996. According to an embodiment, the digitally printable layer has a gloss value at 60° comprised in the interval from 10 to 90, preferably in the interval from 20 to 80 and even more preferably in the interval from 25 to 75. The gloss value is measured according to EN ISO 2813:2014. The opacity of the digitally printable layer could be greater than 90%, preferably greater than 95% and even more preferably greater than 97%. The opacity of the digitally printable layer is measured according to DIN 53146. The opacity O is the ratio between the reflectance Rₒ and the reflectivity R_{∞}:O=Rₒ/R_{∞}, wherein the reflectance Rₒ is the reflectance of the digitally printable layer over perfect black and the reflectivity R_{∞} is the reflectance of the same digitally printable layer on a pile of identical digitally printable layers which is so thick that it is opaque. DIN 53145 defines the requisites for determining the reflectance Rₒ and the reflectivity R_{∞}.

The first thermoplastic composition is, preferably, based on PVC. The first thermoplastic composition may be a blend comprising virgin PVC and recycled PVC. Alternatively or additionally to virgin PVC, the first thermoplastic composition may comprise the following virgin polymers: PE (polyethylene, including LDPE, HDPE etc.), ABS (acrylonitrile butadiene styrene), PP (polypropylene), polyvinyl acetate (PVA), polyvinyl alcohol (PVOH), other vinyl and vinylidene (co)polymers, polystyrene (PS), styrene copolymers, propylene copolymers, polyesters, acrylics, polyamide, polycarbonate (PC), polyimide, polysulfone, or a combination thereof. The first thermoplastic composition is preferably provided as a suspension PVC (S-PVC) comprising recycled PVC granules.

As used herein, “darkener” refers to a substance that imparts a darker shade to the first thermoplastic composition. Darkeners are typically used in a variety of forms, such as discrete particles, dispersions and/or solutions. The darkener may include pigments (organic or inorganic) and/or dyes. Pigments are preferred. Exemplary pigments include carbon black, iron oxide black, bone black, lamp black, ivory black. Carbon black is preferred.

It will be appreciated that the present invention allows for producing much more versatile substrate sheets without necessarily increasing the production cost thereof. Indeed, the use of recycled PVC allows for proportionally reducing the amount of virgin material in the finished product. The inventor has found that accurately controlling the shade of the support layer (comprising recycled PVC), which lies below the digitally printable layer and an overlying digitally printed décor, greatly improves the constancy of the quality of the final decorative floor or wall covering, e.g. over several production batches. For example, two different tiles of the final decorative floor or wall covering having the same décor and digitally printable layer may look different (e.g. darker, brighter) globally or locally due to recycled PVC originating from different sources and therefore having e.g. different compositions, colours, shades. In addition, digitally printing a décor offers great flexibility in terms of printed patterns, especially when compared to the calendaring of the printing layer, as proposed in EP 3 326 815 A1. Patterns may also easily be changed, even on the fly, by configuring the digital printer.

Preferably, the step of admixing the darkener is performed so that the pigments are close packed within the support layer so that they cannot move over one another.

According to an embodiment, the step of admixing the darkener comprises adding darkener to the first thermoplastic composition so as to obtain a first thermoplastic composition having a darker shade, and comparing the darker shade with the specific shade. Based on the comparison, if necessary, the above steps are repeated until obtaining the first thermoplastic composition having a specific shade. In one embodiment, the step of comparing the darker shade with the specific shade is carried out in the following way. A sample of the first thermoplastic composition having a darker shade is compared to a reference sample having the specific shade. If the darker shade and the specific shade mismatch within certain limits, it is considered that the darker shade corresponds to the specific shade. The steps of adding darkener and comparing the obtained darker shade are thus not repeated. If the mismatch is greater that the certain limits, it is considered that the darker shade does not correspond to the specific shade. The above steps are repeated. In other words, a matching tolerance for the specific shade may be used for determining if the above steps should be repeated or not. As used herein, a shade lying inside the matching tolerance for the specific shade is said to match the specific shade within the matching tolerance. In a second embodiment, a plurality of samples of the first thermoplastic composition may be obtained, each of them having different darker shades (obtained by adding different amounts of darkener). Each of the samples are compared with the reference sample having the specific shade. The sample having the darker shade matching the specific shade within said matching tolerance is selected. In case no sample matches within said tolerance, the above step is repeated with a plurality of other samples having darker shades comprised between the two samples lying the closest in terms of shade. One of the two selected closest samples has a lighter shade than the specific shade and the other of the two closest samples has a darker shade than the specific shade. At the end of the admixing step, the amount of darkener to add for obtaining a first thermoplastic composition having a specific shade is known.

Preferably, the matching tolerance is set so that the specific shade “s” ((L*ₛ, a*ₛ, b*ₛ) in CIELAB colour space) and the darker shade “d” ((L*_{d}, a*_{d}, b*_{d}) in CIELAB colour space) differ from one another by a value of ΔE of at most 5, preferably by a value of ΔE of at most 3, more preferably by a value of ΔE of at most 1, wherein ΔE is computed according to

ΔE=\sqrt{(L*ₛ−L*_{d})²+(a*ₛ−a*_{d})²+(b*ₛ−b*_{d})²}.

According to an embodiment, the step of admixing a darkener to the first thermoplastic composition is implemented as a negative feedback loop so as to obtain the first thermoplastic composition having the specific shade by adding darkener to the first thermoplastic composition. The amount of darkener added to the first thermoplastic composition is determined by the negative feedback loop so that the shade of the first thermoplastic composition tends more and more to the specific shade after each iteration, until the shade of the first thermoplastic composition matches the specific shade within the matching tolerance.

Several ways for determining the shade of the samples may be contemplated. For example, a spectrophotometer may be used. Alternatively or additionally, a calibrated camera may be used for taking digital pictures of the sample in a controlled environment (e.g. lighting).

The first thermoplastic composition could comprise from 10% to 50% by weight, preferably from 15% to 35% by weight, more preferably from 17% to 32% by weight of recycled PVC granules.

The first thermoplastic composition could comprise from 30% to 70% by weight, preferably from 35% to 65% by weight, more preferably from 45% to 55% by weight of one or more fillers.

The one or more fillers may be one or more organic and/or inorganic fillers e.g. selected from the group consisting of bauxite, tale, mica, dolomite, barite, kaolin, silica, glass, calcium carbonate, chalk, colloidal or amorphous silica, magnesium oxide, clay or any combination thereof. Examples of organic fillers are cellulosic or polymeric fibres (e.g. wood flour or saw dust).

The first thermoplastic composition could comprise from 0.01% to 0.1% by weight, preferably from 0.02% to 0.075% by weight, more preferably from 0.025% to 0.05% by weight of darkener.

The second coextruded layer could have a thickness comprised in the interval from 0.1 mm to 5 mm, preferably in the interval from 0.1 mm to 3 mm, more preferably in the interval from 0.1 mm to 1 mm, even more preferably in the interval from 0.1 mm to 0.3 mm.

The first coextruded layer could have a thickness comprised in the interval from 2 mm to 15 mm, preferably in the interval from 3 mm to 12 mm, more preferably in the interval from 4 mm to 10 mm.

A second aspect of the present invention relates to a method for producing a decorative floor or wall covering. The method comprises providing a substrate sheet in accordance with the first aspect of the present invention and digitally printing a décor on the digitally printable layer.

As used herein, digital printing refers to methods for printing a digital image on a substrate sheet, more particularly on a digitally printable layer. Examples of digital printing methods include inkjet printing and laser printing. In inkjet printing methods, the image is formed by projecting droplets of an ink onto the digitally printable layer. The ink may include pigments and/or dyes as colorants.

The décor is preferably printed directly on the digitally printable layer.

The method may comprise applying a wear layer on, preferably directly on, the digitally printed décor. The wear layer may be translucent or transparent.

As used herein, a transparent layer is a layer that allows the transmission of light substantially unaffected. A translucent layer partially allows the transmission of light but without allowing objects to be seen clearly through the layer.

The method may comprise applying a polyurethane-based top layer. According to an embodiment, the polyurethane-based top layer is applied on, preferably directly on, the wear layer. The polyurethane-based top layer may be obtained from a moisture curable composition, a radiation curable (e.g. UV-curable composition) composition or a 100% solids composition. 100% solids refers to a composition essentially free from non-reactive solvents (e.g. containing no water or other (organic) solvent). The polyurethane-based top layer may be translucent or transparent. The polyurethane-based top layer may be a polyurethane top layer.

The wear layer and the polyurethane-based top layer may be applied by any known techniques in the art, for example calendering, extrusion coating, spreading the composition and solidifying the same. The spreading of the composition may e.g. be effected by smooth roll coating, curtain coating, air-knife coating, spray coating and combinations thereof. The solidifying of the composition may be effected e.g. by UV-curing for UV-curable compositions, flashing for water-based suspensions.

Preferably, the décor has a thickness comprised in the interval from 0.05 mm to 1 mm, preferably in the interval from 0.1 mm to 0.8 mm, more preferably in the interval from 0.2 to 0.7 mm. According to an embodiment, the décor is digitally printed on the digitally printable layer according to a pattern. According to an embodiment, the digitally printable layer is not entirely covered by the décor. In other words, the pattern comprises one or more voids. In case of patterned décor, the areas where the décor is digitally printed may have a thickness as recited above. The décor may be one, two or three dimensionally patterned. The décor may be translucent.

A third aspect of the present invention relates to a decorative floor or wall covering obtained by the method according the second aspect of the present invention.

### BRIEF DESCRIPTION OF THE DRAWINGS

By way of example, preferred, non-limiting embodiments of the invention will now be described in detail with reference to the accompanying drawings, in which:

FIG. 1: is flowchart of a method for producing a multilayer decorative floor or wall covering, according to a preferred embodiment of the present invention;

FIG. 2: is a flowchart of process for obtaining a thermoplastic composition having a specific shade;

FIG. 3: is a cross-sectional view of a part of a multilayer decorative floor or wall covering according to an embodiment of the present invention; and

FIG. 4: is a cross-sectional view of a part of a multilayer decorative floor or wall covering according to another embodiment of the present invention.

The reader's attention is drawn to the fact that the drawings are not to scale. Furthermore, for the sake of clarity, proportions between height, length and/or width may not have been represented correctly.

### DETAILED DESCRIPTION OF PREFERRED EMBODIMENTS OF THE INVENTION

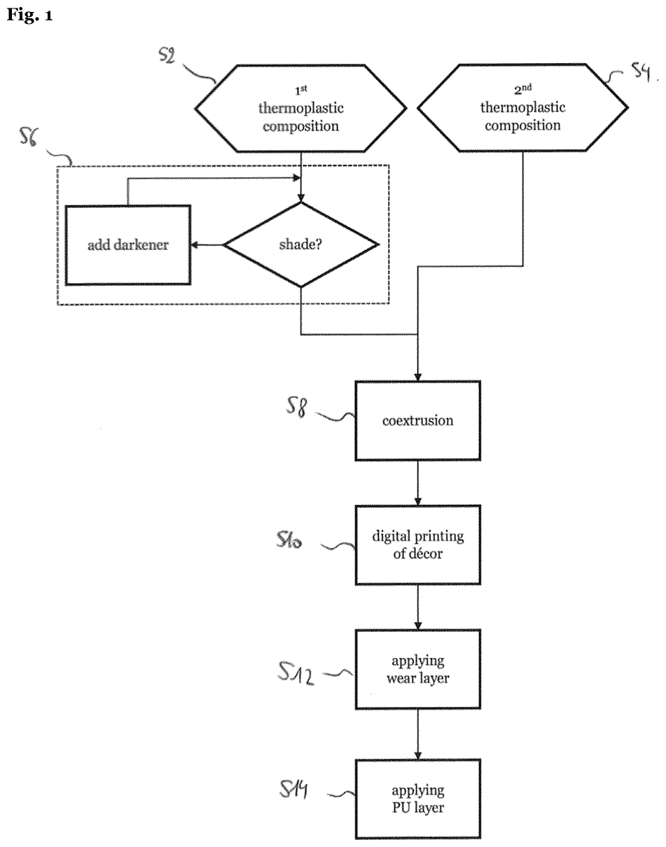

FIG. 1 illustrates a method for producing a multilayer decorative floor or wall covering according to a preferred embodiment of the present invention. The method comprises providing (S2) a first thermoplastic composition comprising recycled PVC granules and providing a second thermoplastic composition, both of which will be coextruded at a later stage so as to form a first and a second adjacent coextruded layers.

The first thermoplastic composition also comprises a virgin PVC (e.g. a suspension PVC (S-PVC), micro-suspension PVC, emulsion PVC) and filler. In addition, the first thermoplastic composition may comprise one or more additives such an impact modifiers, processing aids, (oxidized) polyethylene wax (PE wax) and stearic acid. The first thermoplastic composition comprises from 10% to 50% by weight, preferably from 15% to 35% by weight, more preferably from 17% to 32% by weight of recycled PVC granules. The ratio of virgin PVC and recycled PVC is comprised in the interval from 0.5 to 1.5, preferably in the interval from 0.75 to 1.25. The first thermoplastic composition comprises from 30% to 70% by weight, preferably from 35% to 65% by weight, more preferably from 45% to 55% by weight of one or more fillers.

The PVC granules may originate from different products (e.g. recycled floor or wall coverings, pipes, furnitures, etc). Therefore, the chemical composition and physical properties (e.g. plasticizer content, shade, additive content, etc) of such PVC granules can be accurately controlled only to the extent the mixture of recycled PVC granule is exactly known. In addition, as the first thermoplastic composition is meant to be coextruded, the chemical composition of the PVC granules may vary from batch to batch.

In the next step (S6), a darkener is added to the first thermoplastic composition so as to obtain a first thermoplastic composition having a specific shade. It follows that, at the end of step S6, the first thermoplastic composition has a specific shade, irrespective of the chemical composition of the PVC granules.

The first and second thermoplastic compositions are then coextruded (S8) so as to form the first and a second adjacent coextruded layers. The first coextruded layer is a support layer comprising the first thermoplastic composition. The second coextruded layer is a substantially white digitally printable layer. The second coextruded layer comprises the second thermoplastic composition.

The first coextruded layer has a thickness comprised in the interval from 2 mm to 15 mm, preferably in the interval from 3 mm to 12 mm, more preferably in the interval from 4 mm to 10 mm. The second coextruded layer has a thickness comprised in the interval from 0.1 mm to 5 mm, preferably in the interval from 0.1 mm to 3 mm, more preferably in the interval from 0.1 mm to 1 mm, even more preferably in the interval from 0.1 mm to 0.3 mm. It should be noted that it generally desirable that the thickness of the support layer is greater that the thickness of the digitally printable layer. Indeed, the production costs of digitally printable layers having only virgin PVC and no recycled PVC are usually much higher than the production costs of support layers. For example, the ratio of the thickness of the digitally printable layer and the thickness of the support layer may be comprised in the interval between 0.05 and 0.5, preferably in the interval between 0.1 and 0.4, and more preferably in the interval between 0.15 and 0.3. At the end of step S8, a substrate sheet is produced.

The method comprises digitally printing (S10) a décor directly on the digitally printable layer of the substrate sheet. The digital printing may be effected by inkjet printing or laser printing or a combination of both. The décor may either be in the form of a layer, preferably a layer having a uniform thickness, or a pattern. The pattern may represent a natural design such as wood or stone. The decorative pattern may also be a fantasy design or a photograph.

Subsequently, a wear layer may be applied (step S12) on the décor, followed by the application of a polyurethane topcoat (step S14) on the wear layer. One or the other layers may be omitted.

The wear layer and the polyurethane layer may be applied e.g. by calendering, hot pressing or any other technique known in the art.

The wear layer and the polyurethane are transparent or translucent, so that the décor is visible when looking at the top of the decorative floor or wall covering.

It will be appreciated that accurately controlling the shade of the support layer allows for providing decorative floor or wall coverings comprising recycled PVC with decors having no to little differences in shade, even when the recycled PVC originates from different sources. This is especially the case for very thin digitally printable layers. In other words, darkening the support layer allows for providing digitally printable white layers having an improved constancy for digital printing, which, in turn, allows for providing decorative floor or wall coverings having no to little differences in shade from one coextrusion batch to the other.

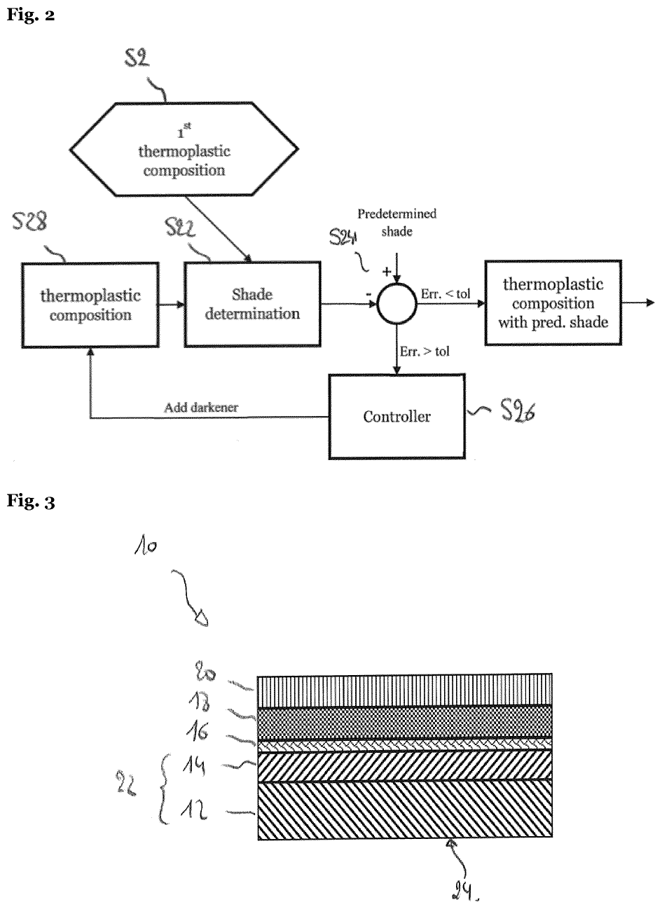

With reference to FIG. 2, the process for obtaining a first thermoplastic composition having a specific shade according to an embodiment of the present invention is detailed.

In step S22, the shade of the first thermoplastic composition (S2) is determined. This step may be carried in various ways. For example, a spectrophotometer maybe used for determining the shade of the first thermoplastic composition. Additionally or alternatively, a calibrated digital camera for taking digital pictures of the composition under controlled lighting may be used. The digital image is then processed for determining the shade of the first thermoplastic composition, in particular the triplet (L*_{d}, a*_{d}, b*_{d}) in CIELAB colour space of the first thermoplastic composition is determined. Preferably, the matching tolerance is set so that the specific shade “s” ((L*ₛ, a*ₛ, b*ₛ) in CIELAB colour space) and the darker shade “d” ((L*_{d}, a*_{d}, b*_{d}) in CIELAB colour space) differ from one another by a value of ΔE of at most 5, preferably by a value of ΔE of at most 3, even more preferably by a value of ΔE of at most 1, wherein ΔE is computed according to

ΔE=\sqrt{(L*ₛ−L*_{d})²+(a*ₛ−a*_{d})²+(b*ₛ−b*_{d})²}.

The determined shade of the first thermoplastic composition is then compared to the specific shade (S24) having the triplet (L*ₛ, a*ₛ, b*ₛ) in CIELAB colour space. In this step, it is determined whether the shade of the first thermoplastic composition matches the specific shade within the matching tolerance. Specifically, the distance ΔE between the shade of the first thermoplastic composition and the specific shade is determined according to ΔE=\sqrt{(L*ₛ−L*_{d})²+(a*ₛ−a*_{d})²+(b*ₛ−b*_{d})²}. The matching tolerance ΔEmax indicates the maximal value of ΔE for determining whether the first thermoplastic composition matches the specific shade within the matching tolerance. The matching tolerance ΔEmax may be equal to 5, preferably equal to 3, even more preferably equal to 1. If the shades match up the matching tolerance (i.e. ΔE≤ΔEmax), the first thermoplastic composition having the specific shade is obtained. If it is not the case (i.e. ΔE>ΔEmax), a controller (S26) instructs an actuator to add darkener to the thermoplastic composition (S28). The thermoplastic composition has now a shade that is darker than before. Steps S22-S26 are repeated until the shade of the thermoplastic composition matches the specific shade within the matching tolerance.

It should be noted that the process defined in steps S22-S28 may be performed on a sample taken from the first thermoplastic composition. The controller stores the amount of darkener that was necessary for obtaining the first thermoplastic composition having the specific shade. The proportion of darkener to be added to the first thermoplastic composition itself is known.

The process for obtaining a first thermoplastic composition having a specific shade may also be carried out differently. For example, a plurality of samples may be extracted from the first thermoplastic composition. Each of the samples are provided with a different amount of darkener (for example in an increasing sequence). The shade of each of the samples is then determined by e.g. a spectrophotometer or a calibrated digital camera and compared, as above. The shade of each of the samples may even be determined by visual inspection. The sample having the shade that matches the specific shade within the matching tolerance, or is the closest to the specific shade is selected. In the same way as before, the amount of darkener to be added to the first thermoplastic composition is obtained by simple cross-multiplication. It should be noted that, in the embodiment where the closest sample is selected, the number of samples (and thus shades) should be quite high so that the selected shade is very close to the specific shade. For example, fifty samples with different amounts of darkener may be prepared, so as to obtain fifty shades of grey for comparison.

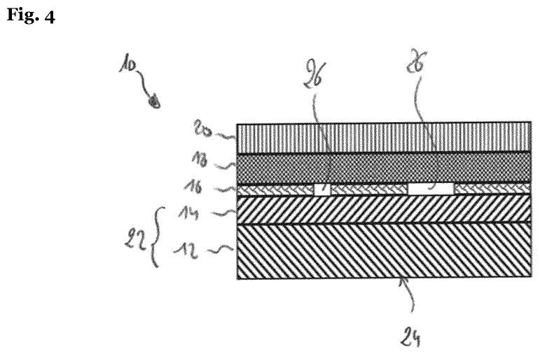

Examples of floor or wall covering 10 according to embodiments of the invention are depicted in FIGS. 3 and 4. From bottom to top, the floor or wall covering 10 comprises: a support layer 12, a digitally printable layer 14, a décor, 16, a wear layer 18 and a PU top layer 20. The support layer 12 and a digitally printable layer 14 form the coextruded substrate sheet 22. During installation of the floor or wall covering 10, the bottom surface 24 of the support layer 12 is applied to the floor or wall.

The embodiment depicted in FIG. 4 differs from the embodiment depicted in FIG. 3 in that the décor is patterned (see e.g. zones 26 that are left untouched by the décor). It should be noted that the zones 26 may be filled by the wear layer, e.g. in the case where the composition for forming the wear layer is applied in a liquid state on the décor, thereby filling the gaps defined by zones 26.

A possible thermoplastic composition for the support layer is provided in Tab. 1 below.

TABLE 1

| | Amount |
|---|---|
| Material | (% by weight) |
| Virgin PVC | 19-23 |
| Recycled PVC | 19-23 |
| Stabilizer | 1-2.5 |
| Impact modifier | 1-2.5 |
| Processing aid | 0.5-2 |
| Filler | 45-70 |
| PE wax | 0-0.5 |
| Filler Compatibilizer | 0.5-2 |
| Stearic acid | 0.1-0.2 |
| Darkener | 0.01-0.1 |
| Total: | 100% |

A possible thermoplastic composition for the digitally printable layer is provided in Tab. 2 below.

TABLE 2

| | Amount |
|---|---|
| Material | (% by weight) |
| Virgin PVC | 22-30 |
| Stabilizer | 1-3 |
| Impact modifier | 1-2.5 |
| Processing aid | 0.5-2 |
| Filler | 45-60 |
| PE wax | 0-0.5 |
| Filler Compatibilizer | 0.5-2 |
| Stearic acid | 0.01-0.10 |
| Whitener | 1-5 |
| Total: | 100% |

The weight percentages in Tab. 1 are given with respect to the thermoplastic composition (for the support layer or the digitally printable layer) as a whole. The virgin PVC is VYNOVA S6760 (Vynova). The stabilizer is Mark CZ 2081 (Galata). The impact modifier is Durastrength 200 from Arkema. The processing aid is LG PA912 from LG. The filler is OMYA BL20 from OMYA. The PE wax is LUWAX Afrom BASF. The filler compatibilizer is Viscowax 443 from Innospec. The stearic acid is stearyna RG from Brenntag. The whitener is Biel tytanowa RFC 5 from Tytanpol (pigment). The darkener is carbon black corax from Orion.

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A method for producing a substrate sheet for a decorative floor or wall covering, comprising:
providing a first thermoplastic composition comprising recycled PVC granules, the first thermoplastic composition having an initial shade;
admixing a darkener to the first thermoplastic composition so as to confer to the first thermoplastic composition a specific shade;
providing a second thermoplastic composition;
coextruding the first thermoplastic composition having the specific shade with the second composition so as to form a first and a second adjacent coextruded layers;
wherein the first coextruded layer is a support layer having the specific shade, the first coextruded layer comprising the first thermoplastic composition; and
wherein the second coextruded layer is a digitally printable layer, the second coextruded layer comprising the second thermoplastic composition.

2. The method according to claim 1, wherein the step of admixing the darkener comprises:
a) adding darkener to the first thermoplastic composition so as to confer to the first thermoplastic composition shade darker than the initial shade;
b) comparing the darker shade with the specific shade; and
c) based on the comparison, if necessary, repeating steps a) and b) until obtaining the first thermoplastic composition having the specific shade.

3. The method according to claim 1, wherein the step of admixing the darkener to the first thermoplastic composition is implemented as a negative feedback loop so as to obtain the first thermoplastic composition having the specific shade by adding darkener to the first thermoplastic composition.

4. The method according to claim 1, wherein the first thermoplastic composition comprises from 10% to 50% by weight of recycled PVC granules.

5. The method according to claim 1, wherein the first thermoplastic composition comprises from 30% to 70% by weight of one or more fillers.

6. The method according to claim 1, wherein the first thermoplastic composition comprises from 0.01% to 0.1% by weight of darkener.

7. The method according to claim 1, wherein the second coextruded layer has a thickness comprised in the interval from 0.1 mm to 5 mm.

8. The method according to claim 1, wherein the first coextruded layer has a thickness comprised in the interval from 2 mm to 15 mm.

9. A method for producing a decorative floor or wall covering comprising:
providing a first thermoplastic composition comprising recycled PVC granules, the first thermoplastic composition having a shade;
admixing a darkener to the first thermoplastic composition so as to change the shade of the first thermoplastic composition into a specific target shade;
providing a second thermoplastic composition;
coextruding the first thermoplastic composition having the specific target shade with the second composition so as to form a first and a second adjacent coextruded layers;
wherein the first coextruded layer is a support layer having the specific target shade, the first coextruded layer comprising the first thermoplastic composition; and
wherein the second coextruded layer is a digitally printable layer, the second coextruded layer comprising the second thermoplastic composition;
and
digitally printing a décor on the digitally printable layer.

10. The method according to claim 9, comprising applying a wear layer on the digitally printed décor.

11. The method according to claim 9, comprising applying a polyurethane-based top layer.

12. The method according to claim 9, wherein the décor has a thickness comprised in the interval from 0.05 mm to 1 mm.

13. The method according to claim 9, wherein the décor is translucent.

14. (canceled)

15. A method for producing a decorative floor or wall covering comprising:
providing a first thermoplastic composition comprising recycled PVC granules, the first thermoplastic composition having an initial shade;
controlledly admixing darkener to the first thermoplastic composition so as to darken the first thermoplastic composition until the first thermoplastic composition has a specific target shade darker than the initial shade;
providing a second thermoplastic composition;
coextruding the first thermoplastic composition having the specific target shade with the second composition so as to form a first and a second adjacent coextruded layers;
wherein the first coextruded layer is a support layer comprising the first thermoplastic composition having the specific target shade; and
wherein the second coextruded layer is a digitally printable layer, the second coextruded layer comprising the second thermoplastic composition;
and digitally printing a décor on the digitally printable layer.

16. The method according to claim 15, wherein the step of controlledly admixing the darkener comprises monitoring whether the darkened first thermoplastic composition has a shade matching the specific target shade; continuing the controlled admixing of darkener as necessary until matching the specific target shade.

17. The method according to claim 16, wherein the first thermoplastic composition comprises from 15% to 35% by weight of recycled PVC granules.

18. The method according to claim 17, wherein the first thermoplastic composition comprises from 30% to 70% by weight of one or more fillers.

19. The method according to claim 18, wherein the first thermoplastic composition comprises from 0.01% to 0.1% by weight of darkener.

20. The method according to claim 19, wherein the second coextruded layer has a thickness in the interval from 0.1 mm to 5 mm and wherein the first coextruded layer has a thickness in the interval from 2 mm to 15 mm.
